(19) United States
(12) Patent Application Publication
(10) Pub. No.: US 2016/0373690 A1
(43) Pub. Date: Dec. 22, 2016

(54) Surveillance system and method

(71) Applicants: Mario A. Campos, Modesto, CA (US); Jorge Campos, Modesto, CA (US)

(72) Inventors: Mario A. Campos, Modesto, CA (US); Jorge Campos, Modesto, CA (US)

(21) Appl. No.: 14/545,776

(22) Filed: Jun. 18, 2015

(51) Int. Cl. H04N 7/14; H04N 5/33; G06T 7/20; H04N 7/18; G06T 7/40

(52) U.S. Cl. CPC H04N 7/147; H04N 7/181; G06T 7/407; G06T 7/2093; H04N 5/332; G06T 2207/10016; G06T 2207/10048; G06T 2207/10036; G06T 2207/30232; G06T 2207/30201; G06T 2207/20221

(57) ABSTRACT

Surveillance techniques to monitor areas to identify persons, faces of persons and fake items are disclosed. Monitoring and recording using remote surveillance units (RSUs) of audio, video, infrared, ultraviolet, infrared and/or lidar is disclosed. The analysis and display of surveillance data with means for analysis and utilizing ghosting is disclosed. In another embodiment, detection of damage by (1) discoloration of a damaged responsive surface or (2) release of a notice gas from a damaged responsive surface is disclosed. The detection of the proximity of an object near a responsive surface due to changes in capacitance is disclosed. In another embodiment, the use of multiple interconnected RSUs with inverted audio alarm means is disclosed.

### FIELD OF INVENTION

This invention relates generally, but not exclusively, to the field of surveillance systems and more particularly to comprehensive systems and methods which compliment general security procedures.

### CROSS-REFERENCE

None. Statement regarding the use of federal funds; no federal funding, direct or indirect, has been utilized in conjunction with the development of the present invention. Statement regarding microfiche records; no microfiche records are used in the application submitted for the present invention.

Pursuant to 35 U.S.C. 122(a), foreign patent filings for the present invention are anticipated.

### PRIOR ART

No prior art can be found which discloses the present invention. Comment is required to understand why this seemingly obvious technology has not been utilized in the past in spite of a long standing need.

The following patents are cited as representative of surveillance related systems and methods. U.S. Pat. No. 8,432,444 (Neuhaus) recites a text related technique. U.S. Pat. No. 8,442,306 (Garaas) recites sensor coverage describing the locations sensors can sense, taking into account occlusions for instance, and how well the sensors can sense a given location and recites that measures, such as spatial resolution and angular resolution, can be used to quantify sensor coverage at a given location. U.S. Pat. No. 8,159,341 (Waugh) recites a system and method for providing monitoring of hazardous materials. U.S. Pat. No. 8,046,313 (Hoffberg) recites an adaptive interface for a programmable system, for predicting a desired user function, based on user history, as well as machine internal status and context. U.S. Pat. No. 7,831,089 (Harville) recites at least one plan-view image which is generated based on depth data. At least one plan-view template is extracted from a plan-view image. The plan-view template is processed by at least one classifier, wherein the classifiers are trained to make a decision according to pre-configured parameters. U.S. Pat. No. 7,731,091 (Knowles) recites a system comprising an area-type illumination and imaging module for projecting a coextensive area-type illumination and imaging field (i.e. zone) into a 3D imaging volume during object illumination and imaging operations. Although all of these patents deal with surveillance, none of these patents teach or involve concepts relevant to the present invention.

### SUMMARY OF THE INVENTION

It is an object of the present invention to provide (1) improved surveillance methods and (2) new evaluation means for recorded surveillance data which include the useful visual and/or automated review of normally uneventful video sequences by utilizing the ratcheting of ghosted sequences.

It is a further objective of the present invention to provide interleaved visual presentations of data derived from more than one media source.

It is a further objective of the present invention to provide means for analysis to include means for ghosting, means for smart scrolling, means for self-consistency analysis and/or means for context analysis.

It is a further objective of the present invention to provide inverted audio alarm means and means for detection of disruption of or disturbance of a responsive surface.

It is a further objective of the present invention to provide a reference data base and means for analysis and/or results therefrom as a service business by selling and/or leasing the same to third parties.

Although these techniques are simple, as a comprehensive approach they provide a broad scope of data acquisition and analysis which has not been available even though the need has been long standing. These and other objects and advantages of the present invention will become clear to those skilled in the art in view of the description of the best presently known mode or carrying out the invention and the applicability of the preferred embodiment as described herein and as illustrated in the several figures of the drawings.

### BRIEF DESCRIPTION OF THE SEVERAL VIEWS OF THE DRAWINGS

FIG. 1 is a schematic view of a monitor connected to a computer with the computer directly connected to a remote surveillance unit (RSU) and also indirectly connected to the RSU by wireless means. Solar and wind generation means for the RSU are shown.

FIG. 2 is a schematic view of an observer communicating with an observed person using an RSU.

FIG. 3 is a schematic view of two RSUs, each utilizing a different source media to create an interleaved sequence.

FIGS. 4A, 4B, 4C and 4D are successive schematic views of an interleaved sequence. FIG. 4B presents a view utilizing a different source media than utilized for FIGS. 4A and 4C. FIG. 4D presents a view utilizing a historic data set.

FIG. 5 is a schematic view of three RSUs intercommunicating with each other with inverted audio alarm means.

FIG. 6 is a schematic partial view of a duct or drain/sewer containing an included item and viewed with an RSU.

FIG. 7 is a schematic perspective partial view of a container on a pallet with equipment and/or supplies, each containing an included item. The pallet exhibits a surface defect.

FIG. 8 is a schematic view of a GRAN (generally recognized as neutral) item or a fake GRAN item.

FIGS. 9 and 10 are schematic sectional side views through a damaged two layer responsive surface mounted on a structure.

FIG. 11 is a schematic sectional side view through a damaged one layer responsive surface mounted on a structure.

FIG. 12 is a schematic perspective view of a hole in the wall of a structure and a hole in an access portal in the-structure.

FIGS. 13-15 are display velocity profiles of an item or a portion of an item.

FIG. 16 is a schematic flow diagram for ghosting.

FIGS. 17 and 18 are time series for mixing for ghosting. FIG. 17 presents a target to reference presentation ratio of 1:1 with no time shift in the start of the reference sequence. The vertical reference line K-K is at a 50-50 mix point for the ghosted sequences. FIG. 18 presents ghosting of the pair of images derived from the K-K vertical line, a time slice.

FIG. 19 is a schematic flow diagram for smart scrolling.

FIG. 20 is a schematic flow diagram for implementation of self-consistency analysis and context analysis.

FIG. 21 is a schematic flow diagram for self-consistency analysis.

FIGS. 22A and 22B are schematic flow diagrams for context analysis.

FIGS. 23 and 24 are ratcheting diagrams for ghosting. FIG. 23 ratchets a sequence from the immediate past. FIG. 24 ratchets from a historic sequence.

### BACKGROUND OF THE INVENTION

Automated security and surveillance systems typically employ video cameras or other image capturing devices or sensors to collect image data. In the simplest systems, images represented by the image data are displayed for contemporaneous screening by security personnel and/or recorded for later reference after a security breach. In those systems, the task of detecting objects of interest is performed by a human observer.

Most major surveillance systems are reasonably effective in dealing with issues related to theft, vandalism and irrational conduct. Deliberate acts-of-war however are commonly the product of detailed preparation, skillful execution and precision as to timing and to the dynamics of a situation.

Defense of persons and property is usually more difficult than offensive undertakings. To the degree that defensive measures are well known, they tend to become less effective. Every sensitive location should be treated as being unique and as having its own vulnerable blind spots. Vulnerability, in part, is tied directly to the knowledge about and the evaluation of a given configuration. In this regard, for high value facilities, it should be assumed that there are no “innocent” events.

There is a substantial difference between safeguarding an auto dealership and safeguarding large industrial facilities such as power production plants from calculated acts-of-war. Although there are similar concerns for these two extremes, the great value of a power plant requires a much more detailed defensive stance. For most power plants, the major areas of concern are; (1) steam turbines, (2) generators, (3) boilers and heat exchangers, (4) transformers, (5) general plant facilities, and, for some hydroelectric facilities, penstocks.

Once basic surveillance methods have been implemented, there are few guidelines as to what additional precautions should be taken. This is not a question of statistics or the likelihood of a given type of event occurring, but a question of the general range of what is improbable and serious.

In the range of improbable threats, defensive measures dealing with fake snakes, rats or ravens, controlled from a satellite and/or preprogrammed, is a tough challenge. Given the creative cleverness of humanity and the rapid advances in nanotechnology, the use of fake animals is a good example of having to defend against the improbable. Another example is the delivery of bogus items with or within validly deliverable equipment and/or supplies (perhaps a given wooden pallet is not just a pallet).

A fake snake or rat that can penetrate reinforced concrete may be a problem, but consider true latent threats. If access can be gained without notice, control over the timing of an event makes the situation even more complex. A fake raven is large enough to carry or contain a lot of innovative items, all of which are deliverable in spite of strong, tall fences.

Normal rational decisions based on return-on-investment thinking fade rapidly when dealing with serious acts-of-war. Given the fairly large number of vulnerable facilities, there are many targets of opportunity for those who are patient and relentless. In such an environment, losses are inevitable. However, the care given to the unique character of each facility should tend to limit, and perhaps avoid, some losses.

The context within which the present invention seeks to achieve risk avoidance requires basic philosophical elaboration in order to provide breadth to the background involved. Act-of-war activities involve and are similar to gang warfare mindsets in which “they hit us, we hit them” is a relevant operational standard for many teenage gangs. One basic rule for a gang is to show that they can take it (i.e., destruction/death).

If a given industry, such as the utility industry, is truly safeguarded, then the threats will shift to less well protected commercial areas. Chemical plants, pipelines and related facilities are particularly vulnerable. Well orchestrated supervision (both sides) tend to follow the axiom of General Robert E. Lee during the civil war; to “keep up the scare.” The long term result of such a situation is a toughing of society. It is not a “good guy” versus “bad guy” type of situation; it is a situation that gradually works itself out.

The general rule is that it takes about 3 generations to establish new standards (e.g., the US civil rights movement). For really basic differences however the standards gradually adjust to a measure of mutual tolerance (e.g., the religious conflicts of past centuries in England). At best, the result then is a grudgingly superficial uneasy acceptance of a dynamic status quo.

The changes involved in broadly accommodating the current economic transition (a major steady contraction of disposable income) require patience, attention to detail and flexibility. The best prospect for a relatively tranquil long term posture is to create populations which are very well educated and which have great multilingual strength. Regular engineering considerations with regard to economies of scale (i.e., larger is cheaper) may have to give way to the use of a multiplicity of smaller units to reduce overall vulnerability.

Currently most of the recorded data sequences obtained from surveillance are unexamined. Heavy reliance is made upon the use of effective sensory triggers to identify events. Thus a huge portion of the recorded data lies dormant and unutilized. The common counter argument to this situation is that the record is largely devoid of interest. This type of response misstates the basic problem. The problem is that it is currently impractical to examine the records in detail. It is clear however that should a situation arise which avoids sensory detection, the records are unused unless a notable event occurs at about the same time.

General Description. To understand the range of applications and the details of implementing the present invention, reference is made to the drawings. Referring particularly to the figures wherein like-reference numbers have been applied to the like-parts throughout the description as illustrated in the several figures of the drawings. The best method for carrying out the present invention is set out below.

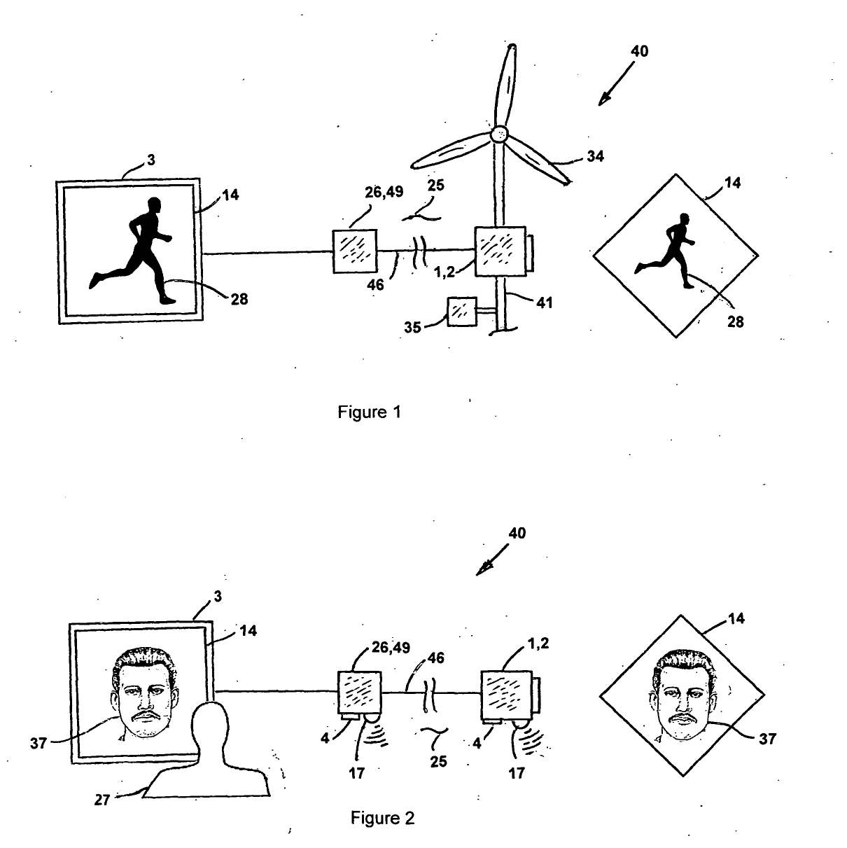

The general configuration for the present invention is designated with the general reference number 40. Referring now to FIG. 1 which is a schematic view of a display means, a monitor 3, connected to a computer 26, a data base 49 and means for analysis on said computer 26, said computer 26 directly connected to at least one remote surveillance unit (RSU) 1,2 and also indirectly connected to said at least one RSU 1,2 by wireless means 25, said at least one RSU 1,2 affixed to a vertical pole 41, solar generation means 35 and wind generation means 34 for said at least one RSU 1,2 affixed to said pole 41, said at least one RSU 1,2 monitoring at least one area 14 thereby producing at least one data set 46 of activities in said at least one area 14 utilizing at least one source media 9,10, said at least one media 9,10 comprising audio data and/or (1) video, (2) infrared, (3) ultraviolet and/or (4) lidar data, communicating said at least one data set 46 to said data base 49, said data base 49 storing at least one historic data set 50, at least one effective match and/or at least one image from said at least one data set 46 identified with said data base 49 and said means for analysis and displayed on said display means 3, said at least one effective match and/or said at least one image comprising (1) said activities in said at least one area 14, (2) at least one item 48, (3) at least one portion 32 of said at least one item 48, (4) at least one person 28 and/or (5) the face 37 of said at least one person 28, optionally displaying said at least one effective match and/or said at least one image with a blank or neutral background 31. For infrared surveillance data, cryogenic cooling of said at least one RSU 1,2 is preferable.

Referring now to FIG. 2 which is a schematic view of at least one observer 27 communicating with said at least one person 28 in said at least one area 14 utilizing said at least one RSU 1,2, said communication facilitated by a first microphone 4 and a first speaker 17 connected to said computer 26, a second microphone 4 and a second speaker 17 connected to said at least one RSU 1,2, said monitor 3 displaying said face 37 of said at least one person 28.

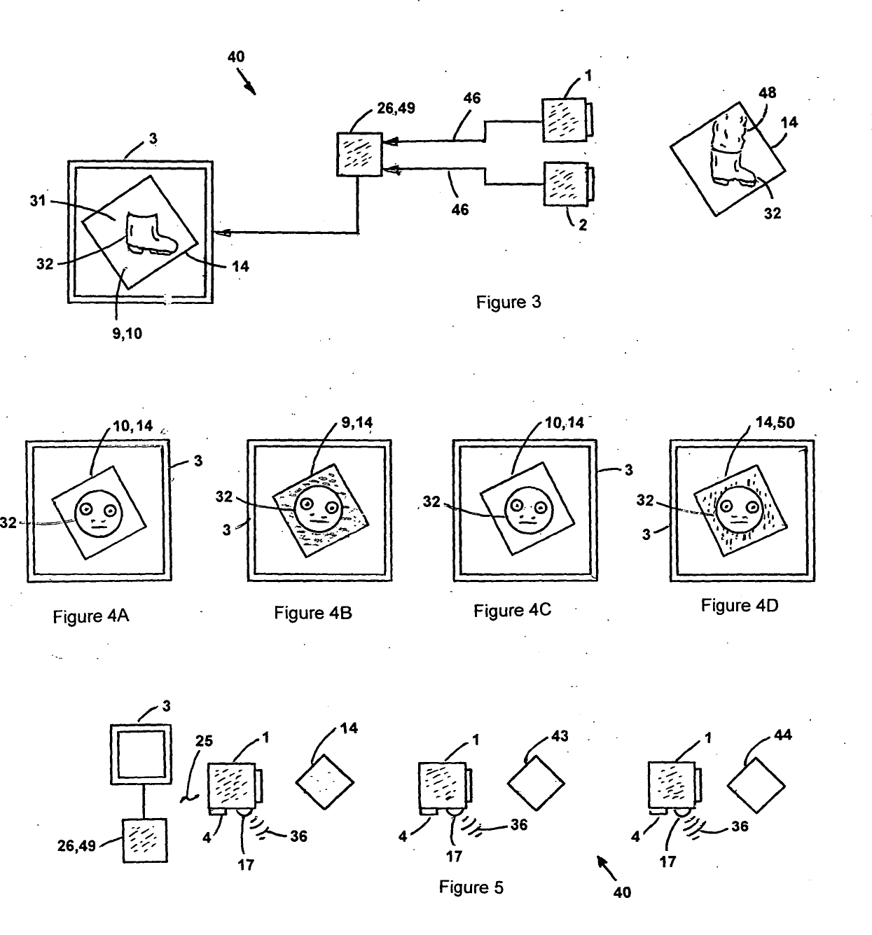

Referring now to FIG. 3 which is a schematic view of two RSUs 1,2 of said at least one RSU 1,2 monitoring said at least one area 14, said first RSU 1 utilizing said audio data and/or one non-audio media 9 of said at least one media 9,10, said second RSU 2 utilizing said audio data and/or a second non-audio media 10 of said at least one media 9,10 thereby creating said at least one interleaved presentation on said monitor 3 of said at least one item 48, said at least one portion 32 of said at least one item 48 displayed.

Referring now to FIGS. 4A, 4B, 4C and 4D which are successive schematic views of said interleaved sequence. FIG. 4B presents a view utilizing said at least one media 9, FIGS. 4A and 4C respectively present prior and subsequent views utilizing said second at least one media 10. FIG. 4D presents a view from said at least one historical data set 50.

Referring now to FIG. 5 which is a schematic view of three RSUs 1,2 of said at least one RSU 1,2 intercommunicating with each other and respectively monitoring three areas 14,43,44 of said at least one area 14 with means for implementing an inverted audio alarm configuration, optionally one of said at least one RSU 1,2 communicating with said computer 26 with said wireless means 25.

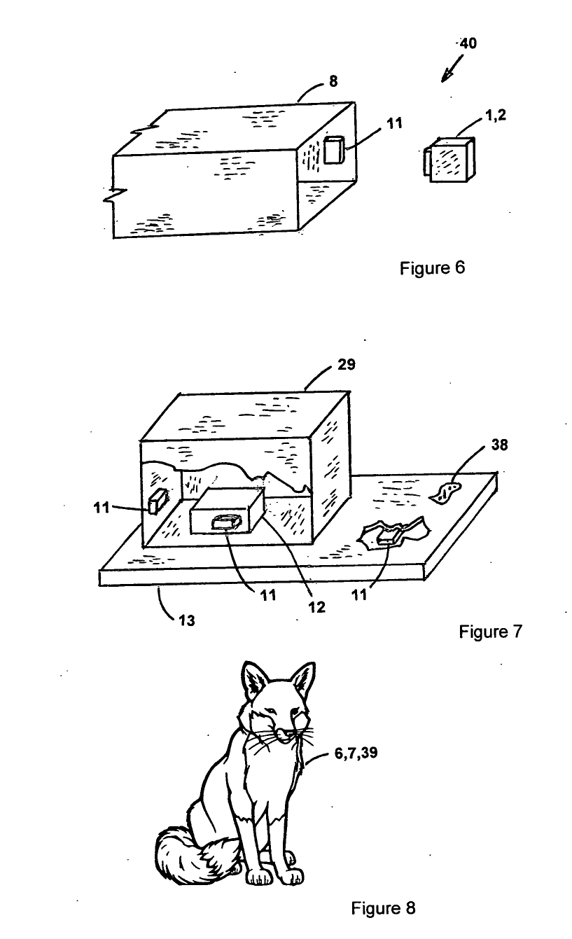

Referring now to FIG. 6 which is a schematic partial view of at least one duct or at least one drain/sewer conduit 8 viewed with said at least one RSU 1,2, at least one included object 11 affixed to an interior surface of said at least one duct or said at least one drain/sewer conduit 8.

Referring now to FIG. 7 which is a schematic perspective partial view of at least one container 29, said at least one container 29 on at least one pallet 13, at least one piece of equipment and/or at least one batch of supplies 12, said at least one piece of equipment and/or said at least one batch of supplies 12 contained within said container 29 and/or on said at least one pallet 13, said at least one included object 11 attached to or contained within said at least one container 29, on or within said at least one pallet 13 and/or on or within said at least one piece of equipment and/or said at least one batch of supplies 12, said at least one pallet 13 exhibiting a surface defect 38.

Referring now to FIG. 8 which is a schematic view of an animate GRAN (generally recognized as neutral) item 6, 39, a fox, or a fake GRAN item 7,39, a fake fox.

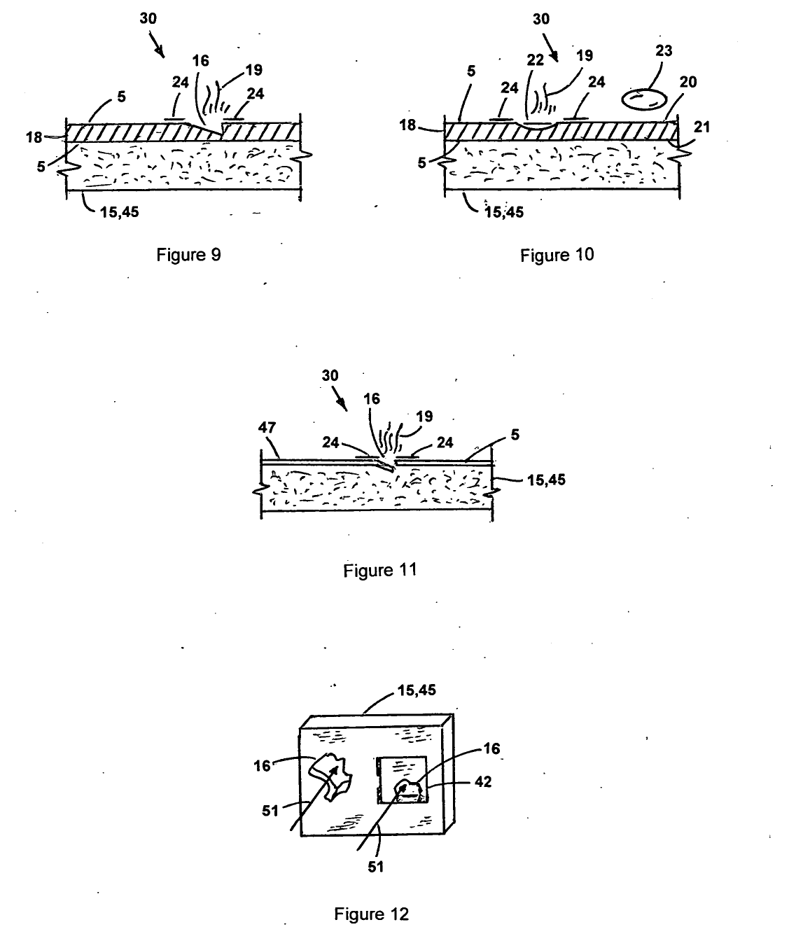

A responsive surface is indicated by the general reference number 30 and comprises (1) two layers 5, an inner layer 5 and an outer layer 5, said two layers 5 separated by and affixed on each side to a central insulation layer 18 or (2) one layer 47. Referring now to FIGS. 9 and 10 which are schematic sectional side views through said two layer responsive surface 30 mounted on a wall 15 of a structure 45. FIG. 9 shows a first break 16 in said outer layer 5 and FIG. 10 shows an indentation 22 in said outer layer 5, discoloration 24 of areas adjacent to said disturbed surfaces 16,22, a notice gas 19, preferably a mercaptan, issuing from said disturbed surfaces 16,22 at said first break 16 and at said indentation 22, means for odor detection (not shown) used to detect said notice gas 19. Each of said two layers 5 of said two layer responsive surface 30 optionally being electrically conductive surfaces, respectively at different voltages V1 20, V2 21, a proximate object 23, said proximate object 23 proximate to said outer layer 5 as shown in FIG. 10, the proximity thereof altering said voltage potential, said V1 20 and said V2 21, between said two layers 5 allowing detection thereof with means for detection of variations in capacitance (not shown).

Referring now to FIG. 11 which presents said one layer 5 responsive surface 30 mounted on said wall 15 of said structure 45, a second break 16 in said layer 5, said discoloration 24 on said layer 5 adjacent to said second break 16, said notice gas 19 issuing at said second break 16.

Referring now to FIG. 12 which is a schematic perspective view of a third hole 16 in said wall 15 of said structure 45, an access portal 42 in said wall 15, a fourth hole 16 in said access portal 42, a motion arrow 51 indicating ingress by said at least one item 48 (not shown) respectively through said third and fourth holes 16.

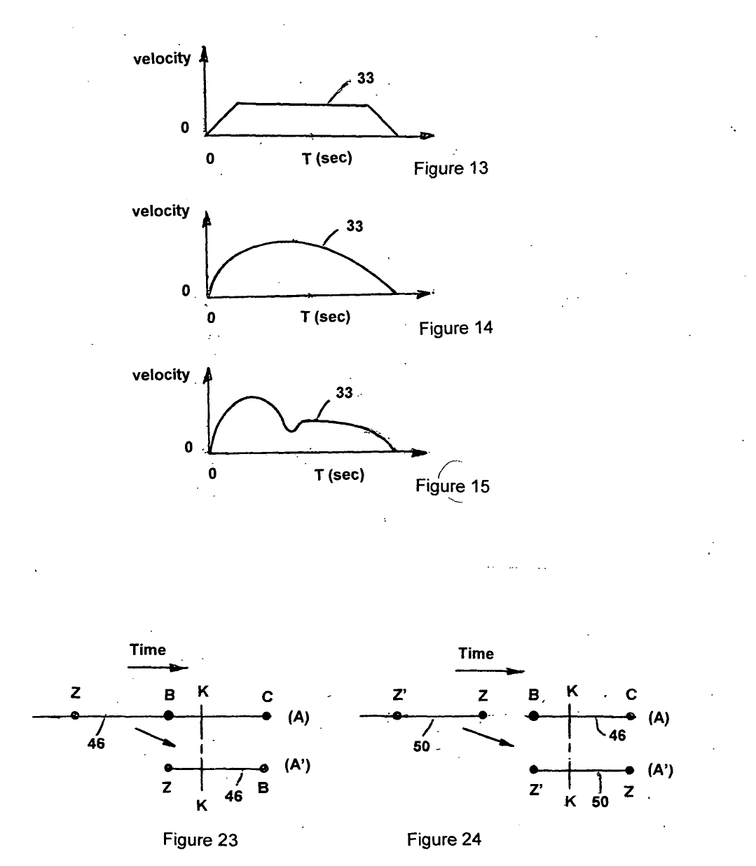

Referring now to FIGS. 13-15, which display at least one velocity profile 33 of said at least one item 48 or of said at least one portion 32 thereof. FIG. 13 displays said at least one profile 33 indicative of uniform initial acceleration, a period of constant velocity and then uniform deacceleration. FIGS. 14 and 15 display said at least one profile 33 with continuous acceleration and/or deacceleration of said at least one item 48 or said at least one portion 32 thereof.

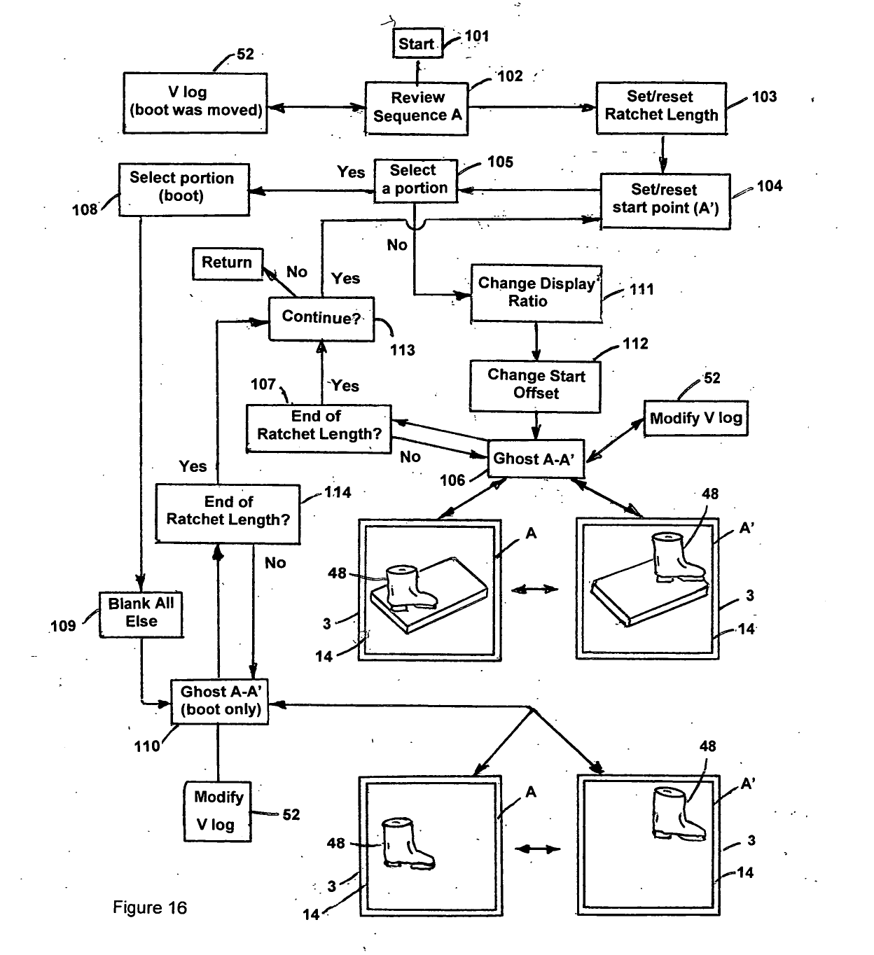

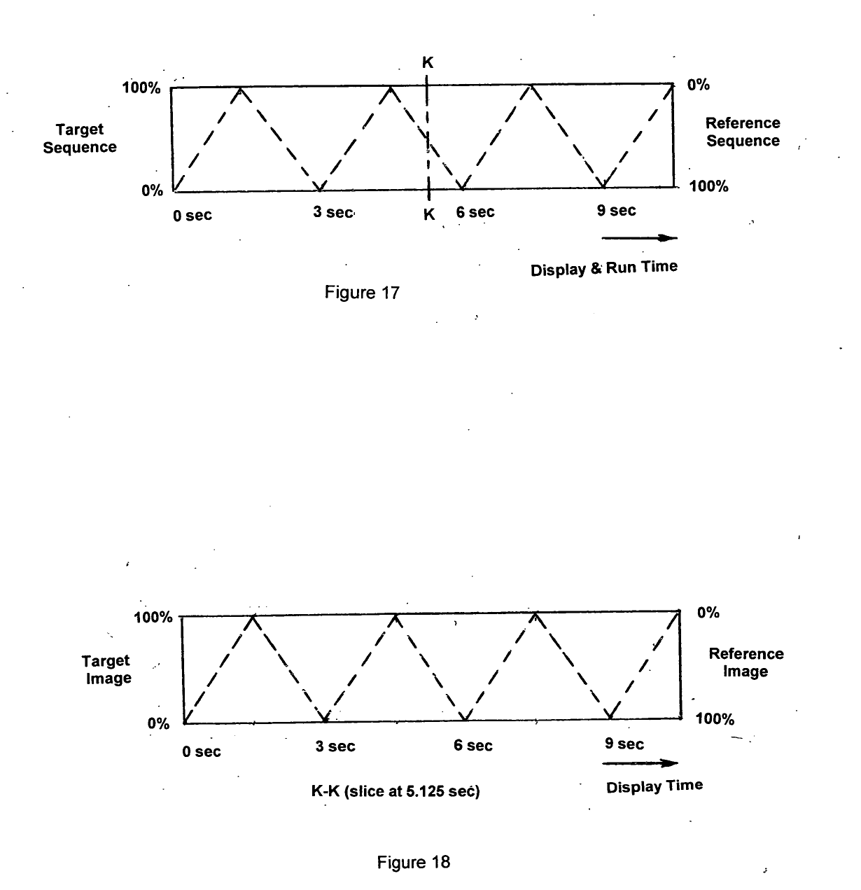

Means for analyzing is defined as including, but not limited to, means for ghosting, means for smart scrolling, means for self-consistency analysis and/or means for context analysis. Referring now to FIG. 16 which is a schematic flow diagram, modules 101-114, for said means for ghosting which is the analysis of pairs of sequences of images or of a pair of images. Analysis with said means for ghosting highlights small differences and distinguishes such variations by fading from a target sequence of images into and out of a superimposed reference sequence of images. Referring now to FIGS. 17 and 18 which present mixing graphs of said means for ghosting, FIG. 17 mixes said two sequences and FIG. 18 mixes said pair of two images. Referring now to FIGS. 23 and 24 which are ratcheting diagrams for ghosting, FIG. 23 presents a comparison of said at least one data set 46 with another portion of said at least one data set 46. FIG. 24 presents ratcheting with a portion of said at least one historic data set 50. When the end of a ratchet length is reached, the next successive length is then started, the process being termed ratcheting. The length of the reference sequence preferably is short, successive lengths of 60 seconds being useful ratchet lengths.

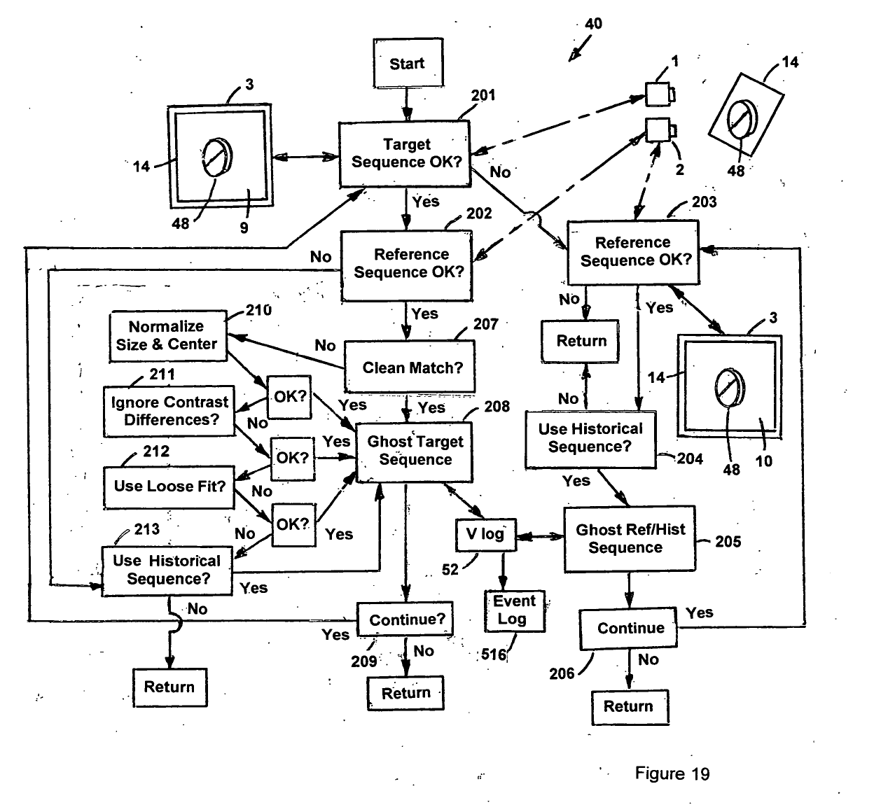

FIG. 19 presents a schematic flow diagram, modules 52,201-213,516, for said means for smart scrolling analysis. Said means for smart scrolling permits the comparison of one sequence of images with another sequence of images by first normalizing the content, size, coloration, positioning and/or background of either or both sequences.

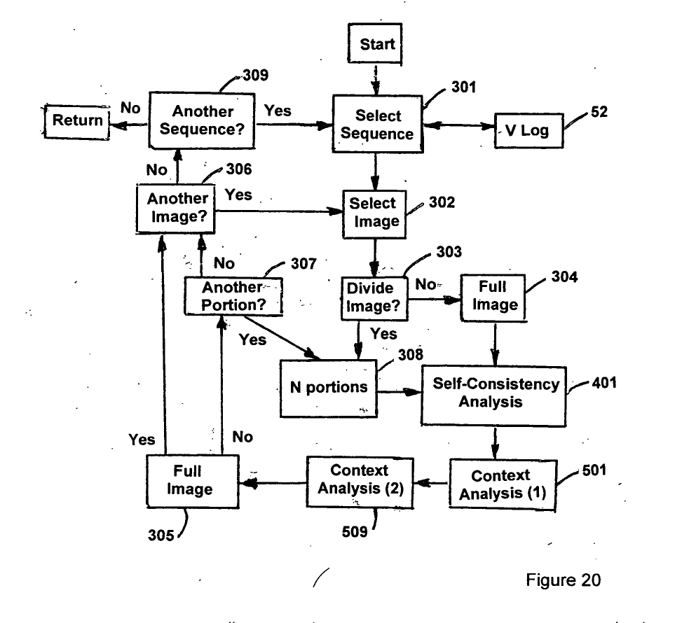

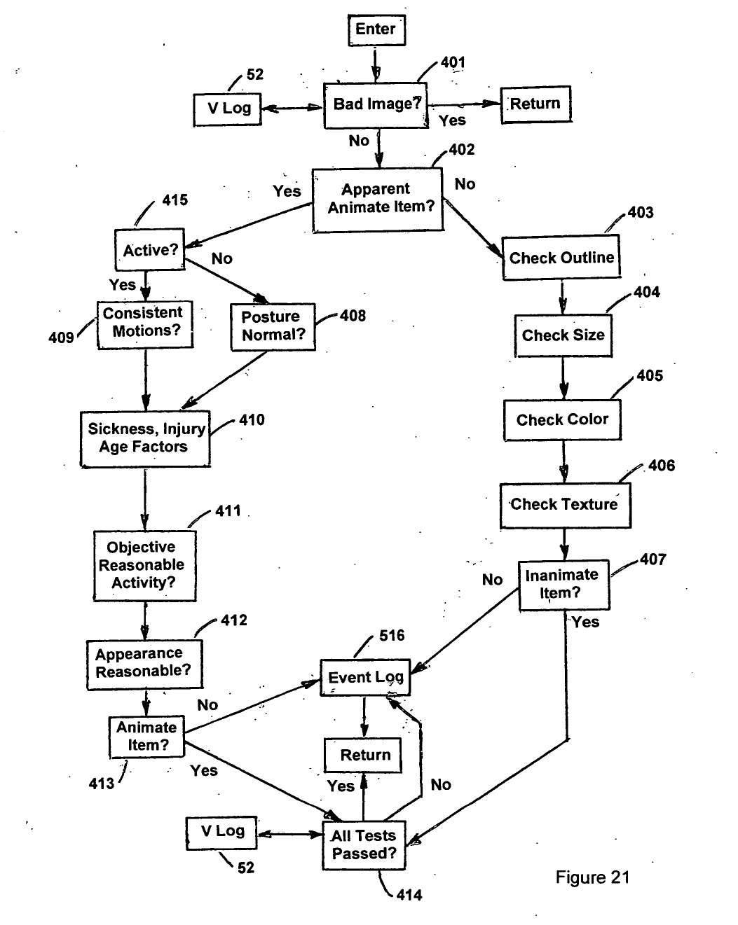

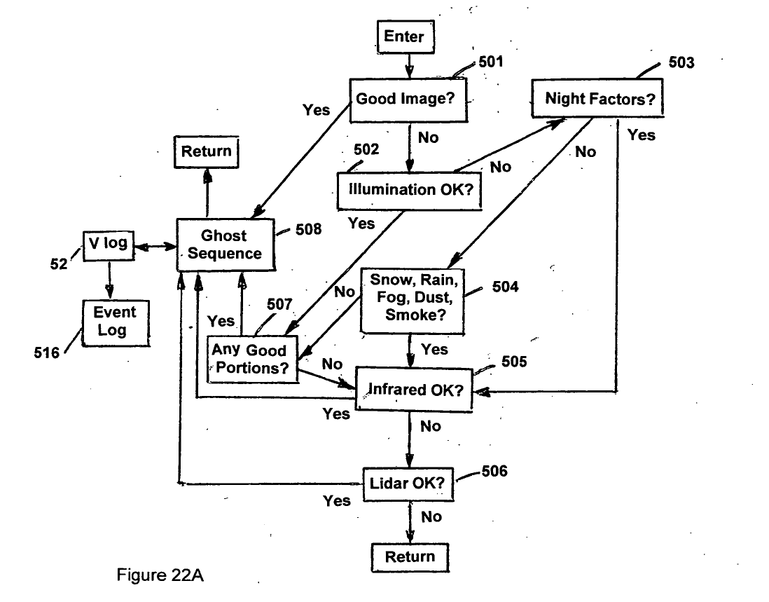

Referring now to FIG. 20 which is a schematic flow diagram, modules 52,301-309, 401,501,509, for implementation of said means for self-consistency analysis and said means for context analysis. FIG. 21 is a schematic flow diagram, modules 52,401-415,516 of said means for self-consistency analysis. Said means for self-consistency analysis is defined as the process of evaluating whether said sequence of images is logically reasonable and self-consistent.

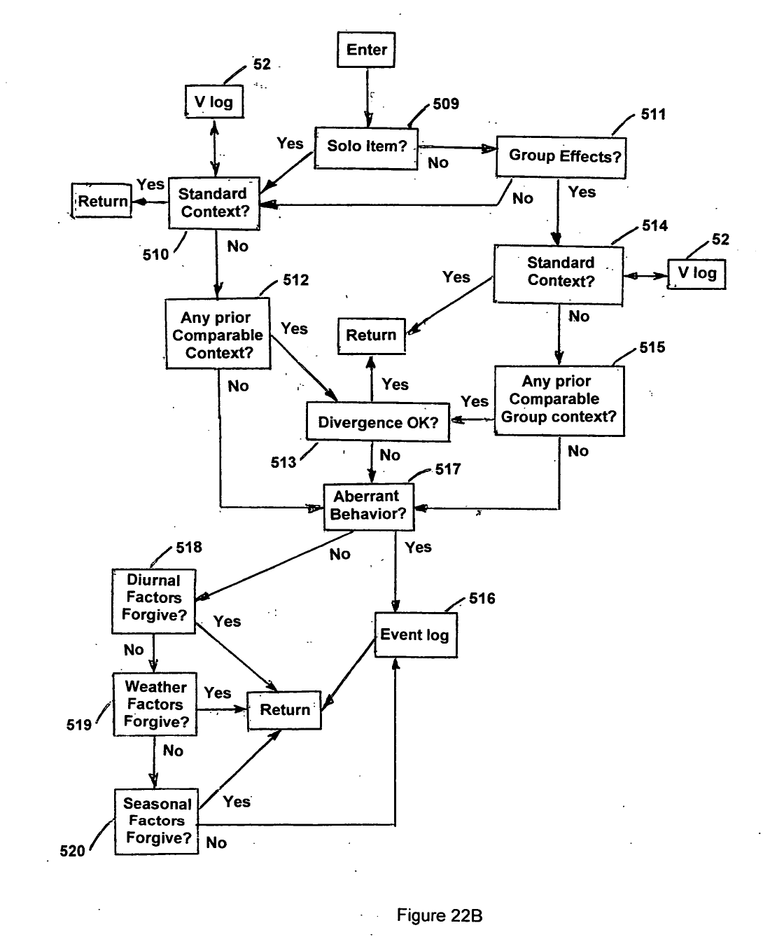

Referring now to FIGS. 22A and 22B which are schematic flow diagrams, modules 52,501-508,509-520, of said means for context analysis. Said means for context analysis is the process of evaluating whether a sequence of images or an image relates logically to its environment and whether the quality and context of the data is adequate and logical.

Detailed Description. Said surveillance configuration 40 comprising said at least one remote surveillance unit (RSU) 1,2, said at least one indoor and/or outdoor area 14 monitored by said at least one RSU 1,2, said at least one data set 46 recorded by said at least one RSU 1,2 of activities in said at least one area 14 with said at least one media, said at least one media comprising audio data and/or (1) video, (2) infrared, (3) ultraviolet and/or (4) lidar data, said at least one data set 46 communicated to said reference data base 49 on said computer 26, said data base 49 further comprising said at least one historic data set 50, said computer 26 provided with said display means 3, means for analysis resident on said computer 26, said at least one effective match and/or said at least one image derived therefrom identified from said at least one data set 46 with said data base 49 and said means for analysis, said at least one effective match and/or said at least one image displayed on said display means 3, said at least one effective match and/or said at least one image further comprising (1) said activities in said at least one area 14, (2) said at least one item 48, (3) said at least one portion 32 of said at least one item 48, (4) said at least one person 28 and/or (5) said face 37 of said at least one person 28, and further, said at least one effective match and/or said at least one image optionally displayed with said blank or neutral background 31, whereby said at least one area 14 is monitored with a surveillance configuration 40.

Said configuration 40 wherein said data base 49 is further comprising said GRAN (generally recognized as neutral) item data and/or said fake GRAN item data, whereby said at least one effective image and/or at least one image further comprising said at least one GRAN item 6 and/or said at least one fake GRAN item 7.

Said configuration 40 whereby said at least one area 14 is further comprising the interior of (1) at least one duct 8, said at least one duct 8 within a structure 45 and/or (2) at least one drainage/sewer conduit 8, said at least one drainage/sewer conduit 8 in or from said structure 45, whereby reverse and/or irregular movement of said at least one item 48, said at least one portion 32 of said at least one item 48, said at least one GRAN item 6 and/or said at least one fake GRAN item 7 is monitored.

Said configuration 40 further comprising means for permitting detection of a disruption of or penetration of said structural barrier 15, improper penetration of said access portal 42 into said structure 45, damage to said responsive surface 30 and/or said change of capacitance from proximity of said object 23 near or at said responsive surface 30.

Said configuration 40 further comprising means for interactive communication between said at least one observer 27, said at least one area 14 monitored by said at least one observer 27, and said at least one person 28 in said at least one area 14.

Said configuration 40 wherein said means for analysis is further comprising identification for said at least one item 48, at least one container 29, at least one pallet 13, at least one piece of equipment 12 and/or at least one batch of supplies 12 of; (1) at least one included object 11 thereon or therein, (2) unusual weight distribution thereof, (3) abnormal production and radiation of infrared, ultraviolet, visual frequencies and/or lidar therefrom, (4) a lack of continuity of texture thereof and/or (5) for said at least one item 48, a lack of continuity of motion thereof when said at least one item 48 is apparently animate.

Said configuration 40 wherein said at least one RSU 1,2 further comprising means for (1) portability thereof, (2) airborne use thereof as an airborne drone, (3) being mounted on said pole 41 and/or (4) use with said wind 34 and/or said solar 35 power generation means.

Said configuration 40 further comprising notification means for notification of an alarm condition among or between two or more of said at least one RSU 1,2 with inverted audio alarm means.

Said configuration 40 further comprising the sale or lease of said reference data base 49 and said means for analysis and/or results derived therefrom to third parties as a service business.

A computer program for the analysis of images comprising; said computer 26, means for analysis on said computer 26, at least one pair of sequences of images and/or at least one pair of image on said computer 26, differences between said at least one pair of sequences and/or between said at least one pair of images determined with said means for analysis.

A method for ghosting video images comprising the following steps; providing ghosting software on said computer 26, providing said display means 3 for said computer 26, selecting at least one first video sequence and at least one second video sequence from said at least one target sequence, mixing said at least one first sequence and said at least one second sequence with said ghosting software by periodically varying their respective contributions to a time varying mixture, said mixture thereby repetitively fading back and forth from a substantially full contribution of said at least one first sequence to a substantially full contribution of said at least one second sequence, presenting said mixture on said display means 3, thereby ghosting said images. Providing means for analysis of differences between said at least one first sequence and said at least one second sequence.

### Embodiment No 1

providing means for permitting detection of said damage 16,22 to said responsive surface 30; said means is by providing said at least one surface 5 which, when damaged, results in local surface discoloration and/or the release of said notice gas 19 as shown in FIGS. 9-11.

Said discoloration 24 of an area at a damaged region 16,22 of said responsive surface 30 allows visual detection of the damage. When detection is with said means for ghosting, minor discolorations are more easily noted. This technique is new and are not obvious. The issuance of a notice gas 19 by said damaged responsive surface 30 is detectable by existing technologies.

When visual evidence of damage to a responsive surface 30 is obscured, the ability to detect the damage with said means for detecting notice gas (not shown) provides a material compliment to the use of basic surveillance methods and, as such, this dual functionality is new and not obvious.

For said two layer 5 of said at least one layer 5 responsive surface 30, changes in electrical capacitance at or near said responsive surface 30, due to proximity of said object 23, when used to trigger a switch, is an established technology.

Although this embodiment of the present invention relies upon this technology, the focus of the usage is (1) to establish a stable electrostatic environment and (2) detect subsequent variations to this environment as shown in FIG. 10. This method of detection of variations in a local physical environment from a stable environment is a new method and is not obvious.

The combination of two or all of (1) said surface discoloration means, (2) said notice gas issuance and (3) said electrical capacitance variation means is a new combination and is not obvious.

### Embodiment No. 2

provides means for the use of an inverted audio alarm configuration. The technique utilized for an inverted audio alarm system is based upon the alarm system utilized by a herd of elephants. Each elephant in a herd “rumbles” at a given low frequency 36 and these signals provide a form of spatial continuity for the group. The alarm is silence; when any member of the herd falls silent, others who notice the silence, also fall silent. The frequencies used are low, roughly 1 to 3 cycles per second, and they easily carry for hundreds of yards. When an inverted audio alarm method is utilized with said at least one RSU 1,2, as a group of RSUs 1,2, as shown in FIG. 5, the inherent security of the overall system is materially enhanced.

Existing technologies have significantly refined the ability to compromise wired and wireless communication systems. An inverted audio alarm configuration avoids many of these techniques and renders compromise of such a configuration substantially more complex. Most secure systems rely upon a flexible capability to routinely reestablish disrupted communications. A system based on the inverted audio alarm method however tolerates no pause whatever in its communication links; any pause anywhere is treated as an alarm. The use of said low frequency audio signals 36 which provide links between and among said at least one RSU 1,2 as a group of RSUs 1,2, avoids many potential compromises of existing wired and wireless communication systems. As such, this is a new and nonobvious security method.

### Embodiment No 3

means for ghosting. Said means for ghosting is defined as a process which permits the analysis of pairs of sequences of images and/or a pair of images. An alert observer can easily fail to notice subtle changes in the identity, shape, coloration, size and/or texture of items. By systematically mixing the two sequences these changes are much easier to detect. The process of fading one sequence into another allows an analyst to routinely examine infrequent variations and provides the basis for automating the review process.

At least one variance log (V log), said module 52, is defined as being a special type of at least one event log, said module 516. Said at least one event log 516 documents significant events noted by existing surveillance methods while said at least one V log 52 documents these events and also minor variations from a substantially static configuration. Examples of such minor variances are; (1) the arrival and departure of birds, (2) wind blown pieces of paper and (3) the activities of lizards and mice. The low incident rate for these variations allows for periodic, routine reviews of said at least one V log 52 by an analyst. Of significance is the fact that the absence of slight changes during the time periods between such variances indicates that they lack significance. This broad based approach to the analysis of surveillance data is in contrast to the current situation in which heavy reliance is placed upon the use of sensor alarm systems to determine when a serious event has occurred. Existing surveillance data normally is mainly used as a historic record during or after the occurrence of major events.

Generally said at least one V log 52 entries are of value when they contain apparently mundane items which are or which may become hazardous or destructive. Entries in said at least one V log 52 which are unexplained and/or which fail specific tests are placed in said at least one event log 516 for more careful review.

Referring again to the schematic flow sequence diagram in FIG. 16, a schematic flow diagram, modules 52,101-114, presents said means for ghosting for said two sequences of images or said pair of images. The target sequence (A) is selected, module 102; the ratchet length is set or reset, module 103; the start or restart point (A′) for the reference sequence is set or reset, module 104; determination is made to select all or a portion of an image, module 105; determination is made to change the display ratio (6:1, 1:1, 1:6, other) which changes the relative presentation speed of one sequence with regard to the other, module 111, the time offset between the two sequences is set or reset (zero, one quarter cycle, one half cycle, ¾ cycle), module 112; ghosting is done for A-A′, module 106; a check is made for the end of the ratchet length, module 107; the background is removable, module 109; the portion selected from A-A′ is ghostable, module 110; a check is made when the end of a ratchet length is reached, module 114, and said at least one V log 52 is modified as required.

Referring to FIGS. 16, 17, said time offset, module 112, for the comparison of said two sequences can be shifted to more clearly present ghosted details. The vertical reference line K-K indicates a 50-50 mix of said at least two sequences at a given point in time. The selection of said two images, one from said target sequence and the corresponding image from said reference sequence at K-K, is an important procedure, however it is an alternative to an analysis made possible by shifting the relative starting points of the two sequences in module 112. Significant and/or unexplained differences from said at least one V log 52 are posted in said at least one event log 516 for detailed review, as shown in FIGS. 19,21,22A,22B.

The efficiency of said means for ghosting is increased when said at least one RSU 1,2 does not vary the field of view; that is, no changes to the view for pan, tilt or zoom for extended periods of time. The resulting historical data is then more easily compared with itself. The essence of this embodiment is that routine surveillance data is compared with itself visually and/or with automated means on a dynamic basis to identify minor events. The need for ghosting has been long standing and has not been available until now. It is a new and nonobvious evaluation process.

Referring now to FIGS. 23 and 24 which respectively present means for context analysis by testing the quality of the data and its general context.

### Embodiment No 4

means for smart scrolling. Said means for smart scrolling is defined as a process whereby one sequence of images derived from said first media source 9, of at least one media source 9,10, is modified for subsequent use of said means for ghosting with a second sequence of images which is derived from said second media source 10, of said at least one media source 9,10. Changes in pan, tilt, zoom, overall magnification and the centering of an item in either or both sequences are made to obtain an effective pairing of images as shown in FIG. 19, a schematic flow diagram, modules 52,201-213,516.

The congruence of the comparison using said means for smart scrolling is further adjustable by (1) altering the overall appearance, including the background, to accommodate variations in lighting levels and/or (2) varying the tolerance of the fit of the contents, outlines, texture and/or coloration of the two sequences. The ability to compare the resulting normalized sequences of images, by adjusting these factors and by using said means for ghosting, is a new and nonobvious evaluation technique.

### Embodiment No 5

means for self-consistency analysis. Referring now to FIG. 20, a schematic flow diagram, modules 52, 301-309,401,501 which presents the implementation of said means for (1) said means for self-consistency analysis, module 401, and/or (2) said means for context analysis, modules 501, 509. The images to be analyzed are divided into workable areas when this is convenient. A favorable result generally requires that the size, texture and color of an item remain constant and that the motions of an animate item have normal fluidity. With regard to such motions, FIG. 13 presents the motions, said velocity trace 33, of a mechanically actuated item, while FIGS. 14,15 present smoother motions, said velocity traces 33 typical of a living organism.

When said means for self-consistency analysis is applied to the evaluation of animate items, their behavioral characteristics are of concern and as these may vary considerably, a broad range of activity is tolerated as normal. It is regarding gross deviations from this range of activity that said means for analysis focuses attention. These include behavior that demonstrates serious injury or illness and irrational activities. Typical abnormal factors would be animals with rabies, tularemia (rabbit fever), malaria and/or parasitic infections. Means for self-consistency analysis, preferably utilized with means for ghosting, is a new and nonobvious analytic tool that permits a broader range of evaluation.

In general, when said means for self-consistency analysis is employed, reliance upon common sense and on the character of the item in question is required. Referring now to in FIG. 21, a schematic flow diagram, modules 52,401-415,516, the initial focus is upon whether or not said at least one item 48 is animate. There is a threshold of commonality and uniqueness that normally begs for careful human attention. It is to the evaluation of this threshold that the present embodiment is addressed.

The tests for animate items include, but are not limited to, (1) consistent motions, (2) normal posture, (3) indications of sickness, injury and/or age, (4) indication of reasonable activities, (5) general appearance and (6) final determination as to being an animate item. The tests for being an inanimate item include, but are not limited to, evaluations for; (1) reasonable outline, (2) average size for such an item, (3) reasonable coloration, (4) reasonable surface texture and (5) a final determination as to being an inanimate item.

This embodiment seeks to identify unusual and/or unexpected attributes of mundane physical items. Thus, if the size of said at least one pallet 13 is too large or too small compared with regular pallets, this would be a matter of interest. Also if the texture of a said at least one piece of equipment and/or said at least one batch of supplies 12 or of said at least one pallet 13, as shown in FIG. 7, indicates unusual characteristics or prior repair, this would be a matter of interest. If the manner of packaging of said at least one container 29 is not ordinary, this would be a matter of interest.

These evaluations of items are frequently site-unique and/or item-unique considerations, however the basic factors of concern for said at least one item 48 are; (1) predictable outlines, (2) standard sizes, (3) regularity of coloration and (4) uniformity of texture. A lack of continuity of texture is defined to include, but is not limited to, surface defects, surface Irregularities, patched repairs, blemishes, scars, variations in wood grain patterns, non-design and/or nonproduction welding or brazing and attached or affixed sections. Said at least one item 48 which fails one or more tests for said means for self-consistency analysis are noted in said at least one event log 516 for more careful review.

### Embodiment No 6

means for context analysis. Said means for context analysis is defined as a process which checks the quality of information available and which correlates images or sounds with normally or commonly associated images or sounds for such information.

FIG. 22A, modules 52,501-508,516, evaluates sequences of images for their inherent quality. FIG. 22B, modules 52,509-521, evaluates sequences of images for congruence with the context within which they are situated. The tests presented in FIG. 22A are; (1) determination that the quality of the images is acceptable, (2) determination that the illumination is adequate, (3) checking for night illumination problems, (4) checking for the use of infrared or lidar, (5) checking for adverse weather conditions, (6) checking for the use of a portion of an image and (6) ghosting said sequences and/or said mages ratcheting.

FIG. 22B, modules 52,509-520, presents tests for said at least one item 48 which include, but are not limited to; (1) determination if more than one item is presented, (2) determination if the context is a standard context, (3) if not in a standard context, determine whether the divergence is acceptable, (4) determination if the displayed behavior is aberrant and (5) determination as to status within contexts which are affected by diurnal factors, weather conditions and/or seasonal factors. Items which fail one or more tests are noted in said at least one event log 516 for detailed review.

Said means for context analysis permits the evaluation of audio and/or visual sequences to confirm that these represent a logical and/or routine progression of events. The use of said means for context analysis, preferably with means for ghosting, is a new and nonobvious analytic tool. Said means for context analysis evaluates environmental factors and evaluates these and other factors which have a direct influence on what is observed.

The uniqueness of many situations demands reconsideration of basic factors. For example, when free running guard dogs are utilized at night, then the inherent attentiveness of the dogs become an important factor in evaluation of the overall risk.

Those skilled in the art will readily observe that numerous other modifications and alterations may be made without departing from the spirit and scope of the invention. It is to be understood that although the varied embodiments of the present invention seem to be separate and distinct concepts, it is their diversity that, as a comprehensive system, provides an effective result. The above disclosure is not intended as limiting and the appended claims are to be interpreted as encompassing the entire scope of the invention. The present invention has industrial applicability.

What is claimed is:

1. A method for providing surveillance of an area comprising the following steps:
providing at least one indoor and/or outdoor area to be monitored,
providing at least one remote surveillance unit (RSU), said at least one RSU monitoring and recording at least one data set of activities in said at least one area utilizing at least one media, said at least one media comprising audio data and/or (1) video, (2) infrared, (3) ultraviolet and/or (4) lidar data, communicating said at least one data set to a reference data base on a computer, said data base further comprising at least one historic data set,
providing said computer with display means and providing means for analysis on said computer,
identifying and displaying at least one effective match and/or at least one image derived therefrom from said at least one data set with said data base and said means for analysis,
said at least one effective match and/or said at least one image comprising (1) said activities in said at least one area, (2) at least one item, (3) at least one portion of said at least one item, (4) at least one person and/or (5) the face of said at least one person, optionally displaying said at least one effective match and/or said at least one image with a blank or neutral background,
thereby providing surveillance for said at least one area.

2. A method for providing surveillance as in claim 1 wherein the step of providing said data base is by further providing GRAN (generally recognized as neutral) item data and/or fake GRAN item data thereon, whereby said at least one effective match and/or said at least one image further comprising at least one GRAN item and/or at least one fake GRAN item.

3. A method as in claim 2 whereby the step of monitoring said at least one area is by further comprising said at least one area as the interior of (1) at least one duct, said at least one duct within a structure and/or (2) at least one drainage/sewer conduit, said at least one drainage/sewer conduit in or from said structure, and monitoring irregular movement therein of said at least one item, said at least one portion of said at least one item, said at least one GRAN item and/or said at least one fake GRAN item.

4. A method for providing surveillance as in claim 1 wherein the step of providing said at least one RSU is by further providing means for permitting the detection of a disruption or penetration of a structural barrier, improper penetration of an access portal into a structure, damage to a responsive surface and/or a change of capacitance from proximity of an object at or near said responsive surface.

5. A method for providing surveillance as in claim 1 wherein the step of providing said at least one RSU is by further providing means for interactive communication between at least one observer, said at least one observer monitoring said at least one area, and said at least one person in said at least one area.

6. A method for providing surveillance as in claim 1 wherein the step of identifying with said means for analysis is by further identifying for said at least one item, at least one container, at least one pallet, at least one piece of equipment and/or at least one batch of supplies; (1) at least one included object thereon or therein, (2) unusual weight distribution thereof, (3) abnormal production and radiation of infrared, ultraviolet, visual frequencies and/or lidar therefrom, (4) a lack of continuity of texture thereof and/or (5) for said at least one item, a lack of continuity of motion thereof when said at least one item is apparently animate.

7. A method for providing surveillance as in claim 1 wherein the step of providing said at least one RSU is by further providing said at least one RSU with means for use (1) as a portable RSU, (2) as an airborne RSU drone, (3) mounted on a pole and/or (4) with wind and/or solar power generation means.

8. A method for providing surveillance as in claim 1 wherein the step of providing said at least one RSU is by further providing notification means for notification of an alarm condition among or between two or more of said at least one RSU with inverted audio alarm means.

9. A method for providing surveillance as in claim 1 wherein the step of providing said at least one RSU is by further providing said data base and said means for analysis and/or results derived therefrom as a service business by selling and/or leasing the same to third parties.

10. A method for analyzing differences between at least one pair of sequences of images or between at least one pair of images comprising the steps of:
providing a computer,
providing means for analysis on said computer,
providing said at least one pair of sequence of images or said at least one pair of images on said computer,
determining differences between said at least one pair of sequences of images and/or between said at least one pair of images with said means for analysis.

11. A surveillance configuration comprising at least one remote surveillance unit (RSU), at least one indoor and/or outdoor area monitored by said at least one RSU, at least one data set recorded by said at least one RSU of activities in said at least one area with at least one media, said at least one media comprising audio data and/or (1) video, (2) infrared, (3) ultraviolet and/or (4) lidar data, said at least one data set communicated to a reference data base on a computer, said data base further comprising at least one historic data set,
said computer provided with display means, means for analysis resident on said computer,
at least one effective match and/or at least one image derived therefrom identified from said at least one data set with said data base and said means for analysis, said at least one effective match and/or said at least one image displayed on said display means,
said at least one effective match and/or said at least one image further comprising (1) said activities in said at least one area, (2) at least one item, (3) at least one portion of said at least one item, (4) at least one person and/or (5) the face of said at least one person, and further, said at least one effective match and/or said at least one image optionally displayed with a blank or neutral background,
whereby said at least one area is monitored with a surveillance configuration.

12. A configuration as in claim 11 wherein said data base further comprising GRAN (generally recognized as neutral) item data and/or fake GRAN item data, whereby said at least one effective image and/or at least one image further comprising at least one GRAN item and/or at least one fake GRAN item.

13. A configuration as in claim 12 whereby said at least one area is further comprising the interior of (1) at least one duct, said at least one duct within a structure and/or (2) at least one drainage/sewer conduit, said at least one drainage/sewer conduit in or from said structure, whereby reverse and/or irregular movement of said at least one item, said at least one portion of said at least one item, said at least one GRAN item and/or said at least one fake GRAN item is monitored.

14. A configuration as in claim 11 further comprising means for permitting the detection of a disruption of or penetration of a structural barrier, improper penetration of an access portal into a structure, damage to a responsive surface and/or a change of capacitance from proximity of an object at or near said responsive surface

15. A configuration as in claim 11 further comprising means for interactive communication between at least one observer, said at least one area monitored by said at least one observer, and said at least one person in said at least one area.

16. A configuration as in claim 11 wherein said means for analysis further comprising means for Identification for said at least one item, at least one container, at least one pallet, at least one piece of equipment and/or at least one batch of supplies of; (1) at least one included object thereon or therein, (2) unusual weight distribution thereof, (3) abnormal production and radiation of infrared, ultraviolet, visual frequencies and/or lidar therefrom, (4) a lack of continuity of texture thereof and/or (5) for said at least one item, a lack of continuity of motion thereof when said at least one item is apparently animate.

17. A configuration as in claim 11 wherein said at least one RSU further comprising means for (1) portability thereof, (2) airborne use thereof as an airborne drone, (3) being mounted on a pole and/or (4) use with wind and/or solar-power generation means.

18. A configuration as in claim 11 said means for monitoring further comprising notification means for notification of an alarm condition among or between two or more of said at least one RSU with inverted audio alarm means.

19. A configuration as in claim 11 further comprising the sale or lease of said reference data base and said means for analysis and/or results derived therefrom to third parties as a service business.

20. A computer program for the analysis of images comprising;
a computer, means for analysis on said computer,
at least one pair of sequences of images and/or at least one pair of image on said computer,
differences between said at least one pair of sequences and/or between said at least one pair of images determined with said means for analysis.

21. A method for ghosting video images comprising the following steps:
providing ghosting software on a computer,
providing a display means on said computer,
providing at least one target video sequence on said computer,
selecting at least one first video sequence and at least one second video sequence from said at least one target sequence,
mixing said at least one first sequence and said at least one second sequence with said ghosting software by periodically varying their respective contributions to a time varying mixture, said mixture thereby repetitively fading back and forth from a substantially full contribution of said at least one first sequence to a substantially full contribution of said at least one second sequence,
presenting said mixture on said display means,
thereby ghosting said images.

22. A method as in claim 21 wherein the step of mixing is by further providing means for analysis of differences between said at least one first sequence and said at least one second sequence.
